(19) United States
(12) Patent Application Publication
(10) Pub. No.: US 2026/0113660 A1
(43) Pub. Date: Apr. 23, 2026

(54) LOW PHY FLEXIBLE RADIO LINK

(71) Applicant: Fraunhofer-Gesellschaft zur Foerderung der angewandten Forschung e.V., Munich (DE)

(72) Inventors: Thomas HAUSTEIN, Berlin (DE); Paul Simon Holt LEATHER, Berlin-Schlachtensee (DE)

(21) Appl. No.: 19/428,867

(22) Filed: Dec. 22, 2025

Related U.S. Application Data
(63) Continuation of application No. PCT/EP2024/067148, filed on Jun. 19, 2024.

(30) Foreign Application Priority Data
Jun. 22, 2023 (EP) 23181042.5

(51) Int. Cl. H04W 28/04; H04L 1/00; H04W 72/40

(52) U.S. Cl. CPC H04W 28/04; H04L 1/0001; H04W 72/40

(57) ABSTRACT

A device configured for wireless communication in a wireless communication network is configured for a signal processing, SP, for the wireless communication, the SP comprising at least one process. In a first operation mode of the device, the SP is adapted to a first configuration of the SP; and in a second operation mode of the device, the SP is adapted to a second configuration of the SP. The second configuration differs from the first configuration by at least one of: a number of processes executed for the SP; an interconnection between processes of the SP; a substitution of a process of the first configuration by a different process operated in the second configuration; a configuration of the at least one process.

### CROSS-REFERENCE TO RELATED APPLICATIONS

This application is a continuation of copending International Application No. PCT/EP2024/067148, filed Jun. 19, 2024, which is incorporated herein by reference in its entirety, and additionally claims priority from European Application No. EP 23181042.5, filed Jun. 22, 2023, which is also incorporated herein by reference in its entirety.

### BACKGROUND OF THE INVENTION

### 1. Field of the Invention

Example embodiments of the present application relate to the field of wireless communication, and more specifically, to signal processing used for the wireless communication. Some example embodiments relate to providing a low physical layer, PHY, flexible radio link.

### 2. Description of the Related Art

FIG. 1 is a schematic representation of an example of a terrestrial wireless network 100 including, as is shown in FIG. 1A, a core network 102 and one or more radio access networks RAN₁, RAN₂, . . . RAN_{N}. FIG. 1B is a schematic representation of an example of a radio access network RANₙ that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANₙ may include more or less such cells, and RANₙ may also include only one base station. FIG. 1B shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1B shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1B by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1B by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIGS. 1A and 1B, for example in accordance with the LTE-Advanced Pro standard or the NR (5G), new radio, standard.

In mobile communication networks, for example in a network like that described above with reference to FIGS. 1A and 1B, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIGS. 1A and 1B. This is referred to as an “in-coverage” scenario. Another scenario is referred to as an “out-of-coverage” scenario. It is noted that “out-of-coverage” does not mean that the two UEs are not within one of the cells depicted in FIGS. 1A and 1B, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2A is a schematic representation of an in-coverage scenario in which two UEs directly communicating with each other are both connected to a base station. The base station gNB has a coverage area that is schematically represented by the circle 200 which, basically, corresponds to the cell schematically represented in FIGS. 1A and 1B. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signalling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 2B is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 2B which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2A, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 3 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIGS. 1A and 1B. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 4 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

In a wireless communication system by way of non-limiting example such as described above, a telecommunications architecture may be comprised of three integral components: the user plane (UP); the control plane (CP); and the management plane (MP). The user plane/UP also known as the data plane (DP), carries the user data.

### Separating the Control-Plane and User-Plane

In 4G, the user plane protocol stack between the e-Node B and UE consists of the following sub-layers: packet data convergence protocol (PDCP), radio link control (RLC), and medium access control (MAC). The control plane includes the radio resource control (RRC) layer which is responsible for configuring the lower layers. The management plane of a networking device is the element within a system that configures, monitors and provides management, monitoring and configuration services to all layers of the network stack and other parts of the system.

A concept similar to that used in 4G is carried forward to 5G. In 5G non-standalone for example, the 4G e-Node-B is used as an LTE anchor together with a 5G NR gNode-B whereas in 5G standalone, the 5G-NR gNB is used alone. The UP/CP split is illustrated in FIG. 6 showing a known connection of two UEs 12₁ and 12₂ to the network 14 in a 5G-NR wireless communication system in which a control plane (CP) and user plane (UP) are provided to each UE. UEs 12₁ and 12₂ may communicate with a wireless communication network 14. For example, this may relate to a communication with a same or different entities, e.g., a same base station, different base stations and/or at least one sidelink communication. Each UE 12₁ and 12₂ may utilize or implement a respective control plane 16₁, 16₂ respectively and a user plane 18₁, 18₂ respectively.

The 5G User Plane Function (UPF) is a fundamental component of 3GPP new radio (NR) mobile core infrastructure system architecture. The UPF represents the data plane evolution of a control and user plane separation (CUPS) strategy, first introduced as an extension to existing 4G/LTE Evolved Packet Cores (EPCs) in 3GPP release 14 specifications. CUPS decouples packet gateway (PGW) control and user plane functions, enabling the data forwarding component (PGW-U) to be decentralized. This allows packet processing and traffic aggregation to be performed closer to the network edge, increasing bandwidth efficiencies while reducing network load and latency. The PGW's handling signalling traffic (PGW-C) remain in the core, northbound of the mobility management entity (MME).

The primary goal of CUPS was to support 5G-NR implementations enabling early IoT applications and higher data rates. Committing to a complete implementation of control and user plane separation, however, is a complex proposition which only provides a subset of the advantages adopting a 5G UPF affords, such as network slicing. Deployed within a dynamic cloud native compute infrastructure, the UPF delivers the packet processing foundation for service-based architectures (SBAs). 3GPP 5G-NR also provides for an inter-UE sidelink (SL) connection wherein a control plane and user plane split is possible as shown in FIG. 7 illustrating a concept similar to FIG. 6 but showing an addition of a sidelink 22, e.g., between the UEs 12₁ and 12₂ which provides a further CP 16₃ and/or UP 18₃.

### Disadvantages of Splitting the Control-Plane and User-Plane

Splitting the user plane and control plane in 5G-NR can however introduce potential limitations, not limited to include the following:

Increased latency: Splitting the user plane and control plane may increase latency, as there may be additional processing needed to transfer data between the two planes.

Greater complexity: Splitting the user plane and control plane may also make the network architecture more complex, as there may be additional interfaces and protocols needed to manage the separation.

Increased resource consumption: Separating the user plane and control plane may need additional resources, such as processing power and memory, which could increase the cost of implementing and operating the system.

Interoperability issues: Splitting the user plane and control plane may need changes to legacy systems and may not be compatible with all devices and networks, which could limit interoperability.

Overall, while splitting the user plane and control plane might offer certain benefits—for example, increased flexibility and scalability—it can also introduce potential limitations that need to be carefully considered.

Some example embodiments of the present invention provide for a new CP structure and/or a UP structure that can be used in addition, as an alternative or separately from the existing known CP/UP and/or may be embedded within them either partially or fully.

### Digital Signal Processing Functions

In standardized wireless communication systems, digital signal processing (DSP) at the transmit side and receive side have to be well aligned. For example, in the transmission chain, the transmitter applies “forward” signal processing steps such that the signal distortion caused by the radio and the propagation channel can be “reversed” by the receiver in the reception chain. This is depicted in FIGS. 8A and 8B and FIGS. 9A and 9B known from 3GPP TS 38.202 V 17.3.0 (2022 December) wherein FIGS. 8A and 8B shows a physical-layer model for UL-SCH transmission and FIGS. 9A and 9B shows a physical-layer model for DL-SCH transmission.

In FIG. 8A a digital signal processing 22₁ of a gNode B comprises, for uplink transmission, different processes or steps or blocks including an antenna mapping 24₁, a resource mapping 24₂, a data demodulation 24₃, a coding an resource management, RM, 24₄ and a cyclic redundancy check, CRC, 24₅.

In FIG. 8B a digital signal processing 22′₁ of a UE is matched to the DSP 22₁ and comprises different processes or steps or blocks including an antenna mapping 24′₁, a resource mapping 24′₂, a data demodulation 24′₃ a coding an resource management, RM, 24′₄ and a cyclic redundancy check, CRC, 24′₅.

In FIG. 9A a digital signal processing 22₂ of a gNode B comprises, for downlink transmission, different processes or steps or blocks including the antenna mapping 24₁, the resource mapping 24₂, the data demodulation 24₃, the coding an resource management, RM, 24₄ and the cyclic redundancy check, CRC, 24₅. The processes are, thus similar to the DSP 22₁ whilst being adapted for the downlink.

In FIG. 9B a digital signal processing 22′₂ of a UE is matched to the DSP 22₂ and comprises different processes or steps or blocks including an antenna mapping 24′₁, a resource mapping 24′₂, a data demodulation 24′₃ a coding an resource management, RM, 24′₄ and a cyclic redundancy check, CRC, 24′₅ being also adapted for the downlink.

In practice this means that the DSP should be designed to cover a multitude of expected use cases and propagation environments, therefore being designed to cover a certain range of application requirements with a reasonable number of configurable parameters, e.g. modulation and coding schemes (MCS) or packet repetitions in H-ARQ.

There is, thus, a need to improve wireless communications.

It is noted that the information in the above section is only for enhancing the understanding of the background of the invention and therefore it may contain information that does not form conventional technology and is already known to a person of ordinary skill in the art.

### SUMMARY OF THE INVENTION

An example embodiment may have a device configured for wireless communication in a wireless communication network; wherein the device is configured for a signal processing, SP, for the wireless communication, the SP including at least one process; wherein in a first operation mode of the device, the SP is adapted to a first configuration of the SP; and wherein in a second operation mode of the device, the SP is adapted to a second configuration of the SP; wherein in the second configuration, the device is configured for a flexible user plane and/or a flexible control plane; wherein the second configuration differs from the first configuration by at least one of:
a number of processes executed for the SP;
an interconnection between processes of the SP;
a substitution of a process of the first configuration by a different process operated in the second configuration;
a configuration of the at least one process, the configuration adapted based on adaptation information received after having started the first operation mode and prior to start the second operation mode; and
a configuration of the at least one process, the configuration adapted based on a fallback configuration to compensate for an error in the first configuration.

Another example embodiment may have a device configured for wireless communication in a wireless communication network; wherein the device is configured for receiving, from another device, assistance information, and for determining a requested signal processing requested from the different device based on the assistance information; and to transmit the requested signal processing to the different device; and/or wherein the device is configured to reproduce or reconstruct the signal processing of the different device based on the assistance information and to adapt the signal processing of the device accordingly.

According to another example embodiment, a method for operating a device for a wireless communication in a wireless communication network may have the steps of: configuring the device for a signal processing, SP, for the wireless communication, the SP including at least one process; operating the device in a first operation mode in which the SP is adapted to a first configuration of the SP; and operating the device in a second operation mode in which the SP is adapted to a second configuration of the SP; wherein in the second configuration, a flexible user plane and/or a flexible control plane is provided; such that the second configuration differs from the first configuration by at least one of:
a number of processes executed for the SP;
an interconnection between processes of the SP;
a substitution of a process of the first configuration by a different process operated in the second configuration;
a configuration of the at least one process, the configuration adapted based on adaptation information received after having started the first operation mode and prior to starting the second operation mode; and
a configuration of the at least one process, the configuration adapted based on a fallback configuration to compensate for an error in the first configuration.

The above and other elements, features, steps, characteristics and advantages of the present invention will become more apparent from the following detailed description of the example embodiments with reference to the attached drawings.

### BRIEF DESCRIPTION OF THE DRAWINGS

Example embodiments of the present invention will be detailed subsequently referring to the appended drawings, in which:

FIGS. 1A and 1B show a schematic representation of an example of a wireless communication system.

FIG. 2A is a schematic representation of an in-coverage scenario in which UEs directly communicating with each other are connected to a base station.

FIG. 2B is a schematic representation of an out-of-coverage scenario in which UEs directly communicating with each other receive no SL resource allocation configuration or assistance from a base station.

FIG. 3 is a schematic representation of a partial out-of-coverage scenario in which some of the UEs directly communicating with each other receive no SL resource allocation configuration or assistance from a base station.

FIG. 4 is a schematic representation of an in-coverage scenario in which UEs directly communicating with each other are connected to different base stations.

FIG. 5 is a schematic representation of a wireless communication system comprising a transceiver, like a base station or a relay, and a plurality of communication devices, like UEs, according to an example embodiment.

FIG. 6 shows a known connection of two UEs 12₁ and 12₂ to the network 14 in a 5G-NR wireless communication system in which a control plane (CP) and user plane (UP) are provided.

FIG. 7 shows a schematic block diagram similar to FIG. 6 but showing an addition of a sidelink.

FIGS. 8A and 8B show schematic block diagram of a physical-layer models for UL-SCH transmission.

FIGS. 9A and 9B show a physical-layer model for DL-SCH transmission.

FIGS. 10A and 10B show a schematic block diagram of an example embodiment in which an additional or new digital signal processing (DSP) block may be used in the low PHY.

FIGS. 11A to 11D show schematic illustrations of embodied signal processing functions according to example embodiments to illustrate possible implementations of the present invention.

FIG. 12 shows a schematic block diagram of a wireless communication network that comprises at least one communicating device according to an example embodiment of the present invention.

FIG. 13 shows an alternative inventive improvement over FIG. 6 achieved according to an example embodiment; in a wireless communication network comprises the addition of a flexible control plane and/or a flexible user plane.

FIG. 14 shows a schematic block diagram of a wireless communication network that is a combination of the features of wireless communication networks of FIG. 12 and FIG. 13.

FIG. 15 shows a schematic block diagram of a wireless communication network according to an example embodiment of the present invention.

FIG. 16 showing a schematic block diagram of a wireless communication network according to an example embodiment relating to relaying a message.

FIG. 17 illustrates an example of a computer system on which units or modules as well as the steps of the methods described in accordance with the inventive approach may execute.

### DETAILED DESCRIPTION OF THE EXAMPLE EMBODIMENTS

Equal or equivalent elements or elements with equal or equivalent functionality are denoted in the following description by equal or equivalent reference numerals.

In the following description, a plurality of details are set forth to provide a more thorough explanation of example embodiments of the present invention. However, it will be apparent to one skilled in the art that example embodiments of the present invention may be practiced without these specific details. In other instances, well-known structures and devices are shown in block diagram form rather than in detail in order to avoid obscuring example embodiments of the present invention. In addition, features of the different example embodiments described hereinafter may be combined with each other, unless specifically noted otherwise.

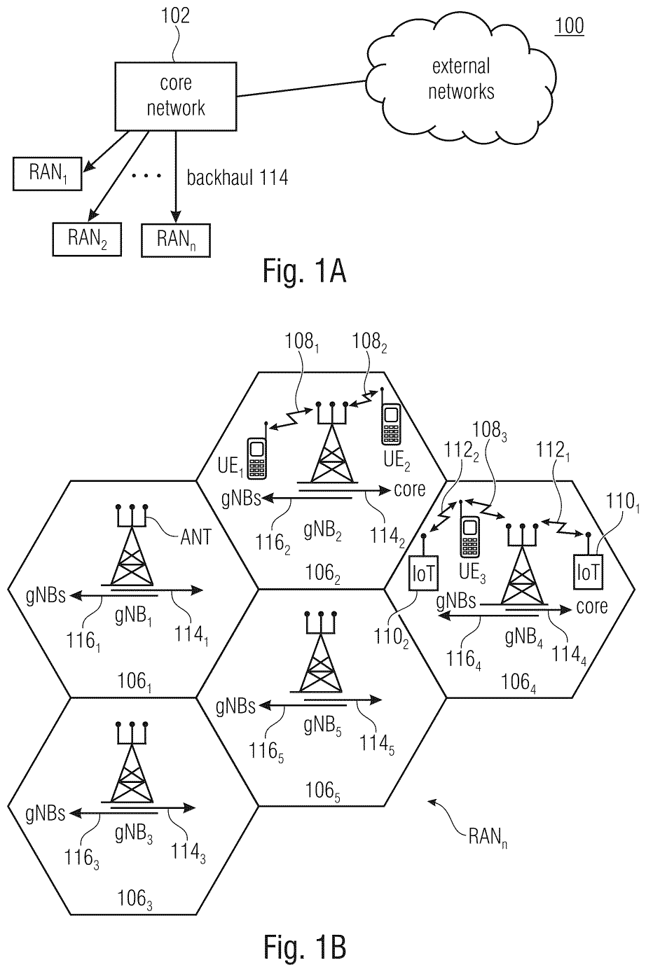

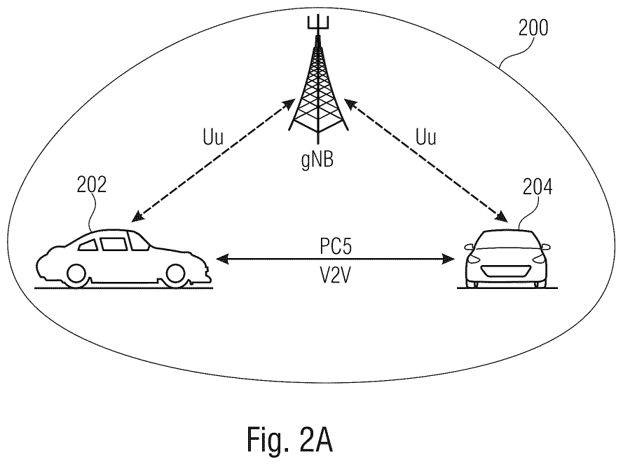

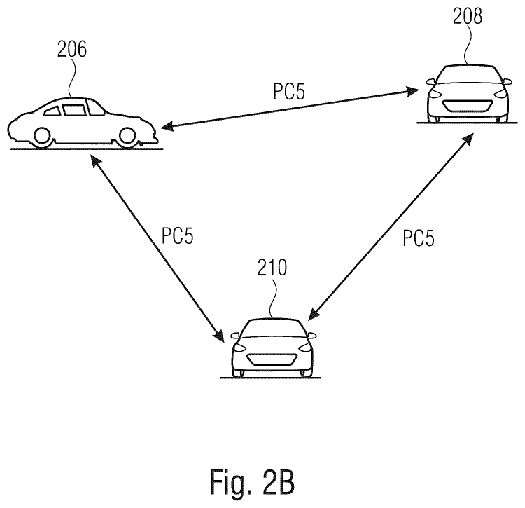

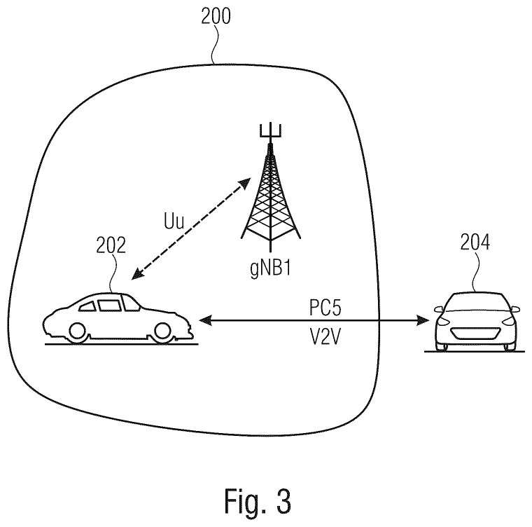

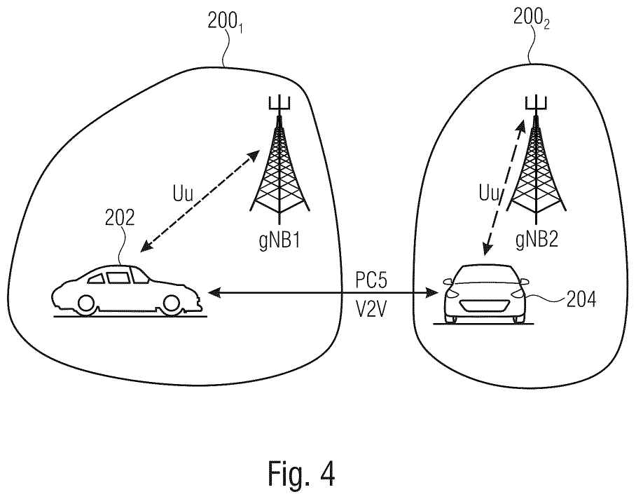

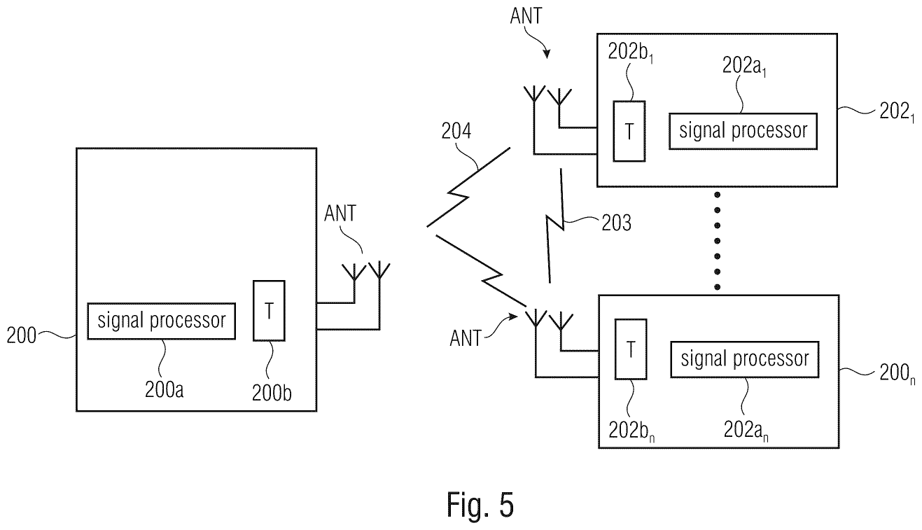

Example embodiments of the present invention may be implemented in a wireless communication system or network as depicted in FIGS. 1 to 4 including a transceiver, like a base station, gNB, or relay, and a plurality of communication devices, like user equipment's, UEs. FIG. 5 is a schematic representation of a wireless communication system comprising a transceiver 200, like a base station or a relay, and a plurality of communication devices 202₁ to 202n, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a1 to 202an, and a transceiver (e.g., receiver and/or transmitter) unit 202b1 to 202bn. The base station 200 and/or the one or more UEs 202 may operate in accordance with the inventive teachings described herein.

In niche or longtail applications—for example, Industrial IoT (IIoT)—that have specific requirements for Ultra Reliable and Low Latency Communication (URLLC) in combination with low-, medium-or high-data rates, the DSP design space requirements easily exceed those of a unified standard set of parameters. A standardized mechanism is thus need to embed domain and application specific DSP requirements for longtail application. To facilitate a DSP alternative on a wireless link between at least two nodes, the transmitter and receiver pair have to be provided with means to be DSP configurable on-demand. This includes without limitation the download of DSP modules and/or code together with their installation, configuration, activation, synchronization and the open-loop or closed-loop control of such DSP modules. These software modules have to be embedded on low PHY or mid PHY in order to provide the needed wireless link enhancements needed for longtail applications. Furthermore, the facilitating scheme proposed by the inventors should allow to embed and use DSP modules which fit into the given standardized and regulatory framework, while being in detail implementation specific and therefore quasi proprietary.

### Inflexible DSP Functionality

Example embodiments of the present invention provide for an increased flexibility of a signal processing (SP), including but not limited to a digital signal processing (DSP). A part of even the complete signal processing may be implemented in an analogue manner without deviating from the present disclosure. According to some example embodiments, a device described herein is to provide at least a part of the SP in a digital domain.

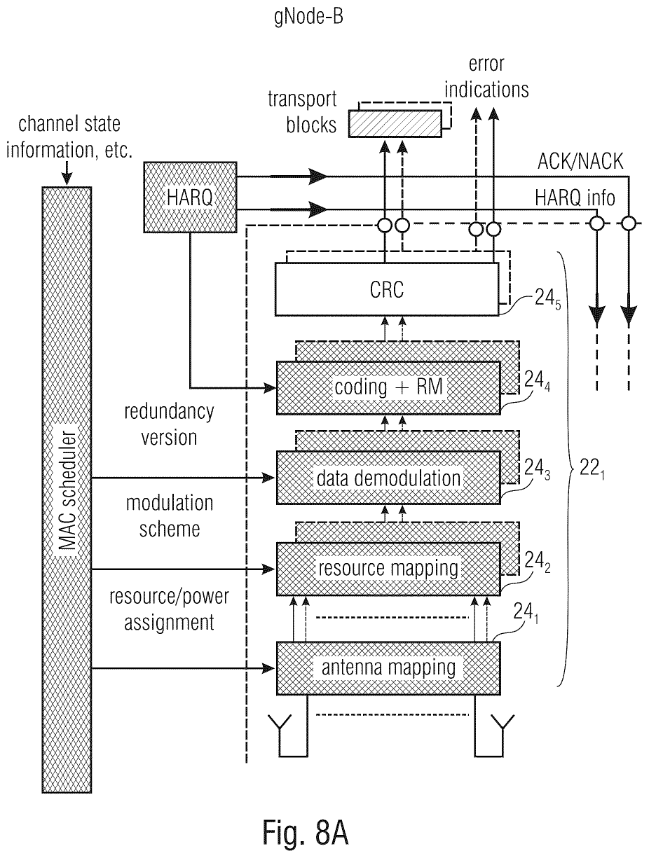

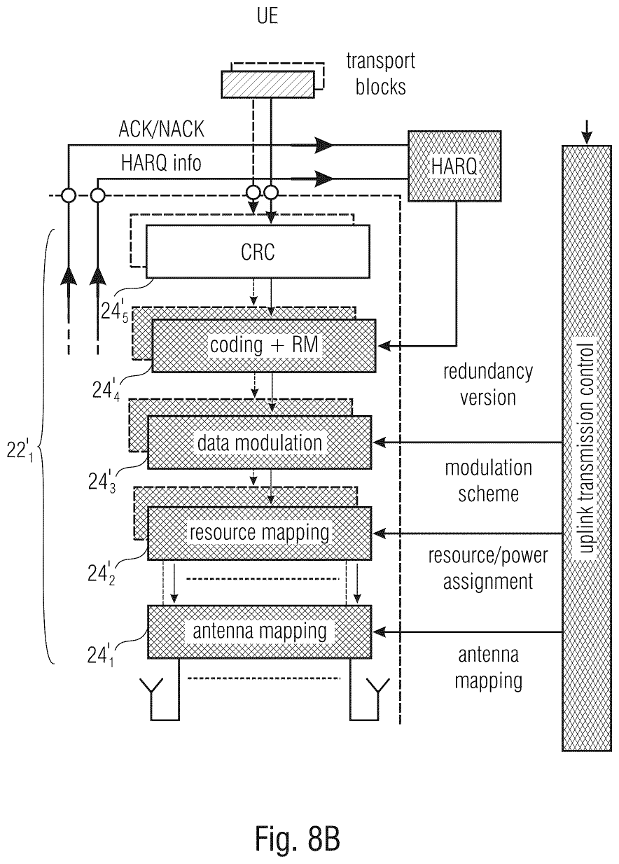

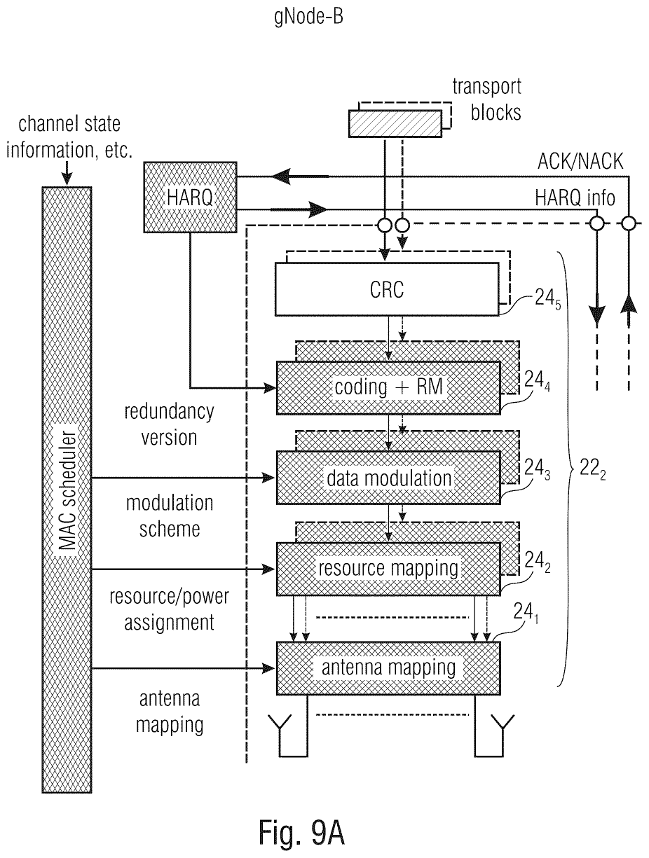

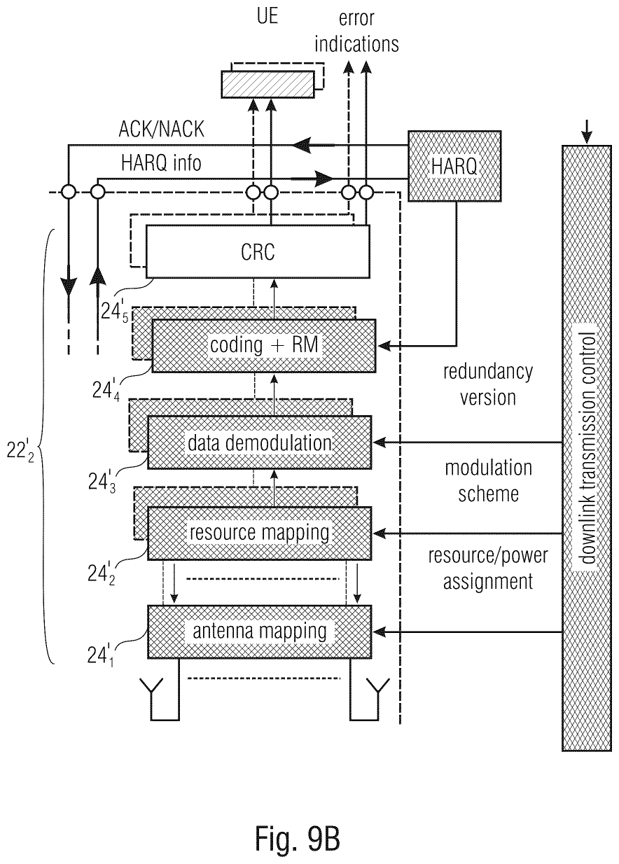

The inventors have found that the limitations set by stringently-standardized DSP solutions may be addressed by providing a framework that allows for the embedment of (D)SP blocks. Such an embedment may be pairwise, i.e., at the receiver and the transmitter of a signal, whilst being not necessarily limited hereto. Whilst a pairwise match may be beneficial as described in connection with FIGS. 8A and 8B and FIGS. 9A and 9B, an example illustrating that such a matching is not necessary relates to, e.g., a satellite with a store and forward feature. If the uplink transmission is in open loop, the UE does not expect a feedback within a LowPHY time limit, therefore the storage time is not or less important. It may, thus, be sufficient for the UE to know that the satellite/partner is in a particular different mode and assume a different behaviour without implementing a (D)SP block in the UE. Therefore, such setting may be almost transparent to the UE, just with reduced/changed expectations towards the behaviour of the other end.

While such blocks do not necessarily have to be standardized per se, a standardized framework may be beneficial for their installation and operation. The proposed framework allows, amongst other things, the introduction of: PHY-apps; PHY-functions; PHY-embeddings; DSP-functions; flexible-DSP-functions; CP-functions; and UP-functions.

To address the problem of inflexible DSP functionality described above, the invention disclosed herein proposes to use a framework in which flexible DSP functions can be installed and operated. Such a framework may be standardized.

Example embodiments relate, amongst others, to a method, a UE apparatus and a BS apparatus that provide for capabilities of the devices and a signalling thereof (D)SP block configuration and reconfiguration, e.g., using download, activation, sync, control, or the like CP and UP establishment and operation in connection with the involved signalling.

Features relating to an activation and deactivation of at least parts of the signal processing.

It is to be noted that example embodiments are not related to adapt a known SP block in a way that is already known in the art, e.g., to use a different antenna gain or the like. Instead, example embodiments relate to the recognition that a reconfiguration of the SP structure itself, e.g., by re-sorting, removing and/or adding at least one SP process may provide for a very flexible signal processing that may be tailored to the individual or local requirement and that may allow to outperform standardized non-flexible configurations. This may include to indicate, directly or indirectly, to a communication partner a request on how to adjust the SP, e.g., which processes or structure thereof to use and to allow the other partner to follow the request; and/or to indicate the capability how to adjust the own SP to provide the other partner with a basis for its request. As an alternative or in addition, example embodiments also relate to indicate, to the communication partner, an own configuration, that allows the partner to adapt accordingly and/or to decide or evaluate which adaptions at the own SP are of benefit or needed and/or to determine, that some adaptation may also be skipped.

Such requests, e.g., received and evaluated to correspondingly adapt the SP configuration and/or to inform the other end about own changes may allow to avoid a failure in communication that is caused by a signal processing on the one end that has no match on the other end.

In known user equipment (UE) and basestation equipment (e.g. gNB), traditional DSP blocks are used which have, as described above, limited the flexibility and effectiveness especially in longtail applications. The proposed technical solution according to example embodiments introduces new or flexible UEs and/or BS or other devices that may contain new or flexible (D)SP functionality inside. Such new/flex UEs will be able to communicate with legacy UEs and flex UEs as well and/or in parallel/simultaneously.

Example embodiments relate to a device that is capable of adapting its signal processing for the transmission case and/or the reception case. Such a device may be or may comprise any device for communicating in a wireless communication network such as network 100, e.g., a user equipment, UE, a base station and/or a relay device. Such a signal processing comprises one or more processes, e.g., functional blocks 24₁ to 24₅ shown in FIGS. 88a through 9b. Beyond a simple straightforward adaptation known in the art example embodiments relate to operate, in a first operation mode of the device with a signal processing that is adapted to a first configuration and to operate the device in a second operation mode of the device with a second configuration of the signal processing. The second configuration differs from the first configuration by at least one of a number of processes executed for the signal processing, an interconnection between the processes of the signal processing, a substitution of a process of the first configuration by a different process operated in the second configuration, a configuration of the at least one process, wherein such a configuration is adapted based on an adaptation information received after having started the first operation mode and prior to start the second operation mode. For example, such adaptation information may be received with a configuration signal, a request signal, or any other way to transmit information. This may allow to implement a configuration that is unknown prior to evaluating the adaptation information. Alternatively or in addition, the second configuration may differ from the first configuration by a configuration of at least one process, the configuration adapted based on a fallback configuration to compensate for an error in the first configuration. For example, when adapting the signal processing, this may result in an error on at least one of both ends of the transmission link. In such a case a predefined fallback configuration may allow to ensure a basis level of communication, e.g., to restart further or subsequent optimization.

Adapting the configuration based on a request signal may be implemented according to a codebook structure, for example. This may allow for a low amount of data to be transmitted, not preventing an explicit transmission of parameters as the request.

According to an example embodiment that may be implemented in addition or as an alternative, the device may evaluate an input information and/or an output information of at least one process of the SP configuration, in particular the first configuration, wherein also an evaluation of the second configuration is possible. An obtained evaluation result may be used for further selections or a basis of further actions. For example, the evaluation may be performed based on measurements provided by the device itself and/or by other devices that may provide for a measurement report. Based on such information, e.g., on how to improve the signal processing according to at least one optimisation criteria, the device may derive the second configuration based on the evaluation result; and may adapt the SP accordingly. Different optimisation criteria may lead to different results. For example, a low energy consumption may lead to a different result for the second configuration, e.g., using a lower number of processes, when compared to an aim to achieve a robust or low-latency communication that avoids retransmits.

According to an example embodiment, the device may implement measurement also on configurations that are used during a test-stage or negotiation phase to obtain an estimation which change in the second configuration compared to the first configuration will lead to which kind of results in the communication. Such knowledge may form a part of a selection of the implementation of the second configuration.

As an alternative or in addition to request another device to adjust its signal processing, a device may also support a different device to decide about the different devices decision which configuration to request from the device and/or to determine which configuration will be selected by the device.

A device according to an example embodiment may transmit to the other device or to an entity of the network assistance information to the different device, e.g., a base station. As the different device may determine its request and/or may reproduce or reconstruct the decision at the device based on the assistance information, the second configuration may be based on or associated with the assistance information.

For example, the assistance information comprises information indicating at least one of:
a transmit power level or a transmit power margin a transmit power spectral density or spectral density margin;
a waveform of a transmitted signal;
an encoding or a configuration thereof, e.g., low density parity check, LDPC, turbo codes, polar codes;
an error correction mechanism;
packet retransmissions;
a diversity scheme and/or a multiplexing scheme;
a transmit and/or receive antenna scheme;
an encryption on one or different layers;
an authentication;
a measure, logging and/or reporting of at least one parameter; and
an encapsulation of specific information or control elements; configurations thereof by suitable parameters or combinations of the above.

To implement the second configuration, the device may, in response to having transmitted the assistance information, select the second configuration based on at least one of:
a reception of a request signal indicating a requested configuration;
a triggering event and/or a triggering threshold, e.g., related to or indicated in the assistance information; and
a selection of the device from a set of preconfigured options.

According to an example embodiment, a device, e.g., a terminal or a base station may receive assistance information and may determine a request that indicates a requested signal processing based on the assistance information. As an alternative or in addition, the device may reproduce or reconstruct the signal processing, based on the assistance information, to understand the signal processing at the other end and may adapt its own signal processing accordingly. Such a device may be a device that may change to the second configuration as described herein or a different device such as a base station coordinating a set of devices and/or a device negotiating the second configuration, e.g., for a sidelink.

For example a device such as a UE may receive a configuration or a related request by the other device, e.g., a gNB; is triggered by an event/threshold and/or may select a new mode of operation, the second configuration, according to preconfigured options based on assistance information provided by the device to the other device. Such assistance information may be provided as a feedback from the device to the other device, e.g., as a message containing at least some of the information indicated above.

### Introduction of New DSP Blocks

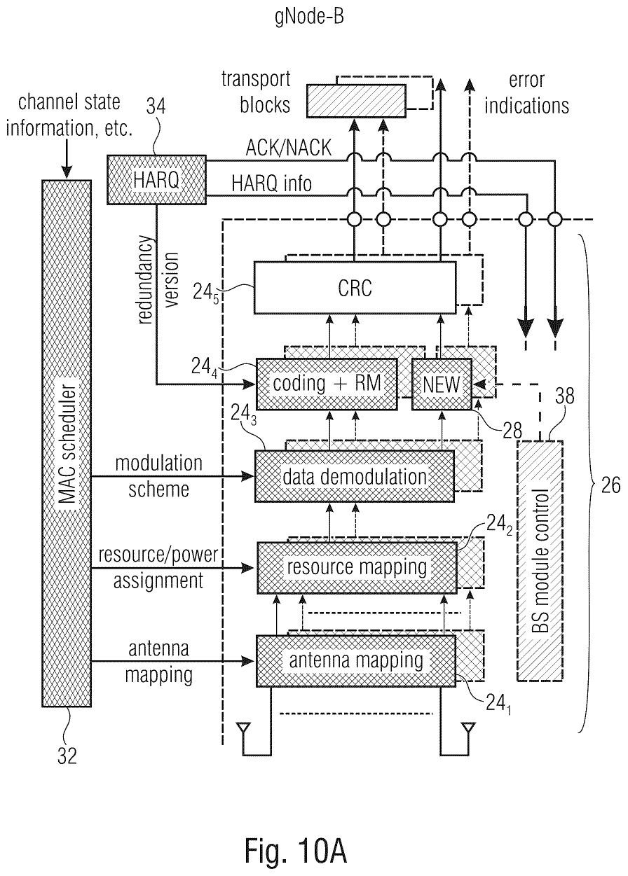

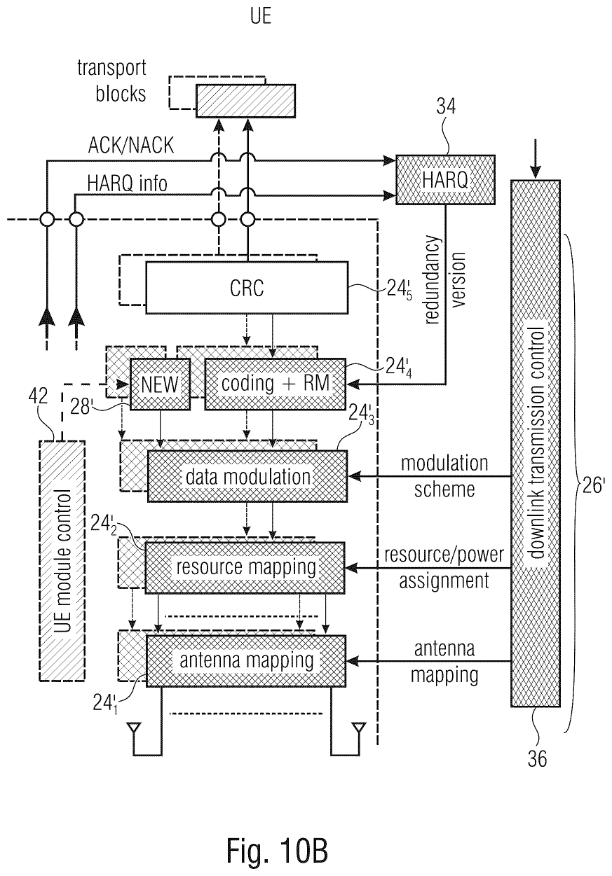

FIGS. 10A and 10B illustrate an example embodiment in which an additional or new digital signal processing (DSP) block 28 may be used in the low PHY that may further comprise processes or blocks 24₁ to 24₄. The shown Physical-layer model relates to UL-SCH transmission including a new low PHY flexible link module used in both gNB, see FIG. 10A, and UE, see FIG. 10B. Such an adaptation may be implemented, as an alternative or in addition for the downlink, DL, and/or at other stages of the signal processing.

The additional process or block 28 may be used by additionally providing a (D)SP function processing at least part of the (signal) data coming from the previous (D)SP block wherein the result/output may serve as an input to the next DSP block in the signal processing chain, e.g., the CRC 24₅.

According to an example embodiment, the new DSP block 28 can, as an alternative or in addition, be used to replace or augment any signal processing block of the device, e.g., the gNB and/or UE. For example, this relates to one or more of blocks 24₁ to 24₄, of the low PHY layer, to a SP block of the mid PHY layer, e.g., a MAC scheduler 32 and/or a HARQ process 34 of a receiving device such as the base station in uplink and/or the HARQ process 34 and/or the an uplink transmission control 36 of a transmitting device such as the UE in the uplink scenario. As an alternative or in addition to the Low PHY and/or the Mid PHY also a process of the high PHY layer may be adapted, substituted, removed or otherwise addressed such as the BS module control 38 and/or the UE module control 42, those modules possibly adapted to control the additional blocks 28, 28′ respectively.

Further examples, that may be implemented as an alternative or in addition may include:
An additional (D)SP block replacing one or more traditional DSP(s) block entirely.
An additional (D)SP block being placed in between two traditional DSP blocks, processing signal data coming from the output of a previous DSP block before entering into the input of the next DSP block.
An additional (D)SP block which bypasses one or more traditional DSP blocks.
An additional (D)SP block which provides forward and/or reverse signal flow paths.
An additional (D)SP block which provides recursive signal flow paths.

Any combinations of the above.

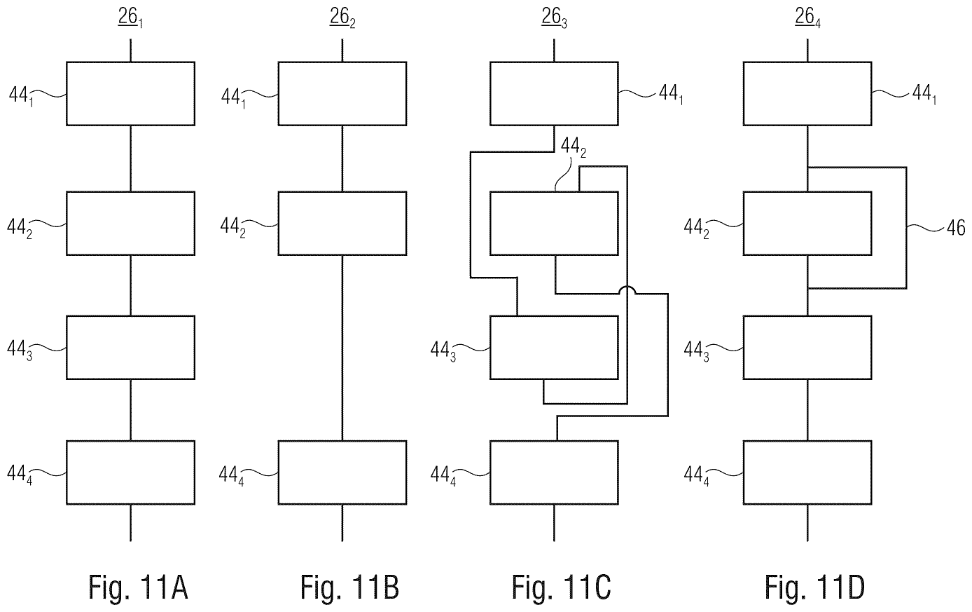

FIGS. 11A to 11D show schematic illustrations of embodied signal processing functions 26₁ to 26₄ according to example embodiments to illustrate possible implementations of the present invention. In FIG. 11A there is shown a signal processing 26₁ comprising, by way of non-limiting example a number of four processes 44₁, 44₂, 44₃ and 44₄. A number of processes in a signal processing according to an example embodiment may be at least one, e.g., 1, 2, 3, 4 or more, such as at least 6, 8 or 10 or even higher numbers. Each of the processes 44₁ to 44₄ may be a known or legacy process 24 or a newly provided process 28.

This may relate to a number of processes that is adapted, reconnected or removed in an overall signal processing or may relate to the overall processing. That is, the respective signal processing 26₁, 26₂, 26₃ and/or 26₄ may show a part or the complete signal processing implemented by a device according to an example embodiment.

Signal processing 26₁ may be seen as a reference for signal processing functions 26₂, 26₃, and 26₄. In signal processing 26₂ shown in FIG. 11B, there is deactivated, disconnected or removed or otherwise omitted one of the processes 44₁ to 44₄ of signal processing 26₁, e.g., signal processing 44₃. This may lead to a configuration according to which signal processing 44₂ provides for an input for signal processing 44₄ that had received its input from signal processing 44₃ according to the configuration of signal processing 26₁. To omit such a process, for example, an encryption and/or encoding may be omitted at the transmitter and/or a respective decryption or decoding may be omitted at the receiver. As a further example, that may be implemented in addition or as an alternative, a path or loop which is used to perform error correction may be additionally added or removed. In the latter case, even though an error correcting algorithm could restore data that is known to be erroneous, it is not. This may result in an unencrypted and/or at least robust transmission, e.g., allowing for a reduced latency. In other words, and by way of an example, in order to reduce the latency of a communication connection, when possible, when requested or otherwise being deemed to be implemented and without effecting other criteria, the level of encryption and/or encoding can be adapted.

According to an example embodiment, that may be implemented in addition or as an alternative to omit a process or a signal processing step, the device may switch off a discrete Fourier transform, DFT, step, e.g., for spreading in frequency domain and/or for localising in time domain. Correspondingly, to switch on or to incorporate the DFT into the signal processing is an example embodiment to increase the number of signal processing processes. As a yet further example to be implemented in addition to one or more of the above or as a further alternative and to omit or decrease a number of processes or to increase the number, a device may switch off, switch on respectively, of a H-ARQ process.

According to the configuration shown in FIG. 11B, a device according to an example embodiment may be configured to implement a signal processing in the second operation mode to comprise a decreased number of processes executed for the signal processing when compared to the first operation mode, e.g., the configuration 26₁. When compared to FIGS. 10A and 10B showing an increased number of processes, a combination of both aspects may result in a substitution of one process, e.g., process 44₃ by another process, e.g., block 28/28′. That is, it is possible but not necessary to increase or decrease a number of processes, e.g., when using a different selected process instead of another process to substitute the latter.

According to an example embodiment, the omitted process 44₃ may comprise a digital twin process. Such a digital twin process may be of particular advantage in some configurations but may be omitted, unwanted or deactivated in other situations.

When referring now to FIG. 11C, there is shown a re-connection of the processes 44₁ to 44₄. In particular, the sequence is changed from 44₁, 44₂, 44₃, 44₄, in configuration 26₁ to 44₁, 44₃, 44₂, 44₄ in configuration 26₃. This is an illustrative example only, any other re-connection that provides for a desired signal processing may be implemented.

When referring now to FIG. 11D, configuration 26₄ shows an additional interconnection for at least process 44₂ by generating a loop 46, wherein such a loop may relate to one or more processes 44 of configuration 26₄. The given examples may be combined with each other without limitations not related to the functionality of the overall signal processing. In particular, in accordance with example embodiments, in the second configuration, the SP may comprise an additional process replacing one or more processes of the first configuration. Alternatively or in addition, the SP may comprise an additional process being executed between a first and a second process of the first configuration, the additional process being configured to processes signal data provided by an output of the first process, a result of the additional process provided to the second process as illustrated in FIGS. 10A and 10B. Alternatively or in addition, the SP may comprise an additional process configured to bypass at least one process of the first configuration. Alternatively or in addition, the SP may comprise an additional process configured to forward and/or reverse a signal flow path of the SP. Alternatively or in addition, the SP may comprise an additional process configured to provide a recursive signal flow path in the SP.

Signal processing described herein may relate to at least one of the UP and the CP of the wireless communication. For example, when considering the example embodiment according to which the second configuration differs from the first configuration by at least the configuration of at least one process, said process may differ in view of a polar coding used in a user plane of the communication to be used in either the first configuration or the second configuration, i.e., it may be switched off in the respective other configuration.

According to an example embodiment, the different signal processing functions or operations may be used or implemented in a sequential manner, i.e., during a first instance of time and for a first communication the first configuration may be used and during a second, different instance of time at the different second configuration may be used. However, this is not necessarily to be implemented. According to some example embodiments, a device described herein may be configured to maintain a first communication using the first configuration and to maintain a second communication using the second configuration. The device may maintain the first communication and the second communication sequentially or in parallel. With regard to maintaining both communications in parallel, it is possible to have different signal processing chains or to switch between the configurations in a fast manner. Beyond fast switching the implementation may also allow for parallel operation of the whole data stream or parts of it. As an example, there may be implemented a decode and forward while additionally the decoded packet may be stored and/or re-encoded providing a new redundancy version for providing incremental redundancy bits if requested for retransmissions.

According to an example embodiment, a device described herein may be configured for implementing a first communication using the first configuration and for implementing a second communication using the second configuration. At least one of the first communication and the second communication may be a sidelink communication. Such a sidelink communication may benefit from a highly flexible configuration of the communication, especially in the longtail market.

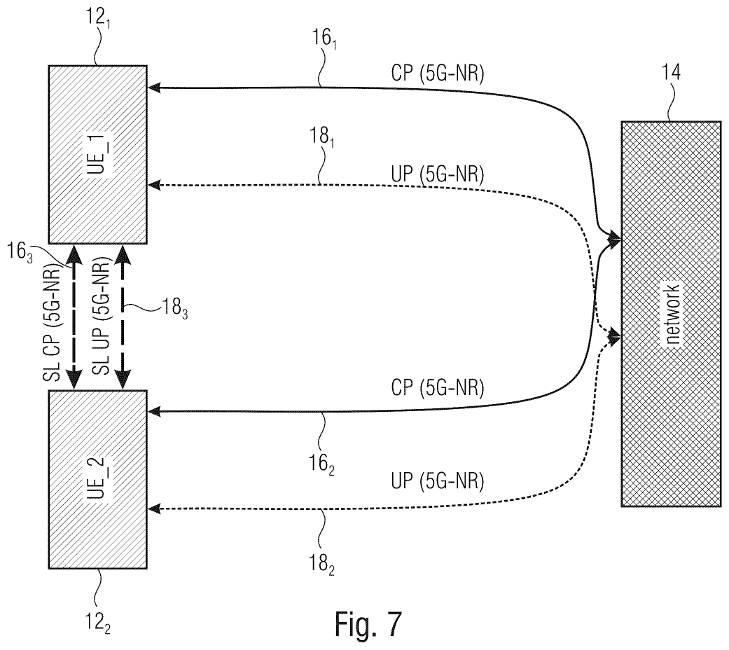

According to an example embodiment, at least one of the first communication and second communication may be an uplink communication or a downlink communication. Any combination is possible, e.g., when referring to FIG. 7.

### Introduction of a New Control Plane, CP, and a New User Plane, UP

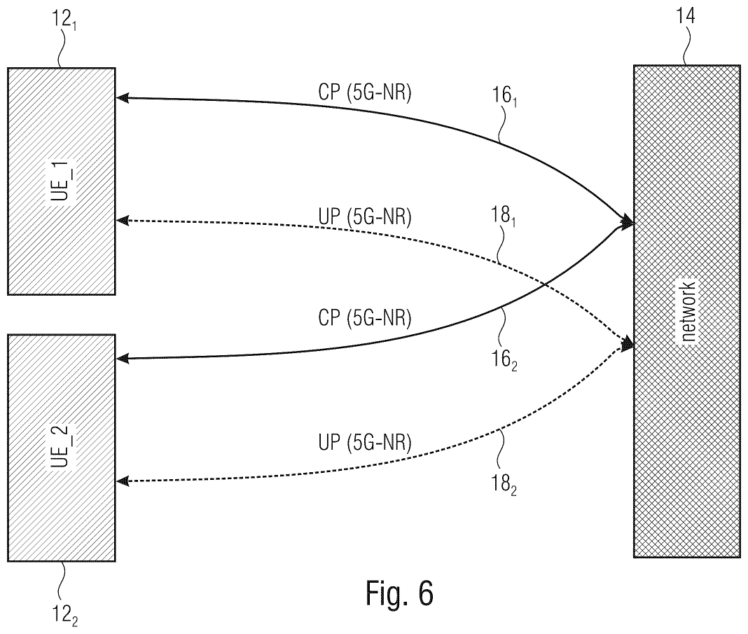

With reference to the 4G/5G control-plane/user-plane split presented in FIG. 6, the following description illustrates how the flexible (D)SP functionality according to the invention may allow a new flexible control-plane and a new flexible user-plane to be used in various implementation together with the existing 5G-NR CP/UP split. That is, in connection with example embodiments, a change in the signal processing may lead to a change in the CP/UP, e.g., based on the plane to which the adapted structure of the SP belongs.

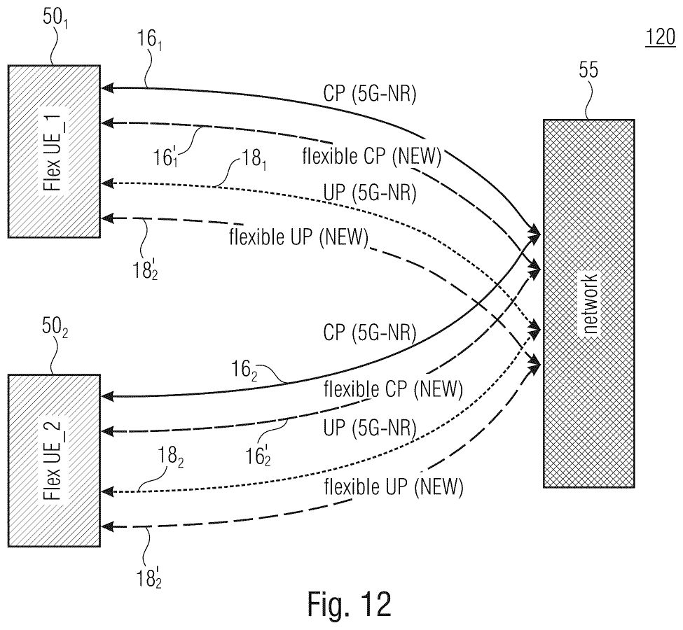

FIG. 12 shows a Schematic Block Diagram of a Wireless communication network 120 that comprises at least one communicating device, e.g., UEs 50₁ and 50₂ that may be in accordance with other UEs described herein, e.g., of FIG. 1 to FIG. 10B being adapted to change their SP configuration as described, e.g., in connection with FIGS. 10A and 10B and FIGS. 11A to 11D. FIG. 12 presents, amongst others the following features:
how Flex UEs 50₁ and 50₂ and the corresponding Flex gNBs of network 55 provide in addition to 5G NR-CP 16 and 5G NR-UP 18 a flexible CP 16′ and/or a flexible UP 18′ to interconnect the Flex DSP blocks
a flexible CP 16′₁ and/or a flexible UP 18′₁ between UE 50₁ and network 55 can be configured independently of a flexible CP 16′₂ and/or of a flexible UP 18′₂ between UE 50₂ and network 55, wherein such independency may be optional or may remain unused when implementing a same configuration
in addition to the above a 5G NR sidelink between UE 50₁ and UE 50₂ and/or further UEs is not excluded.

In other words, FIG. 12 shows an advantageous improvement over FIG. 6 achieved through the addition of flexible control planes and flexible user planes between the user equipment and the network (no active SL shown).

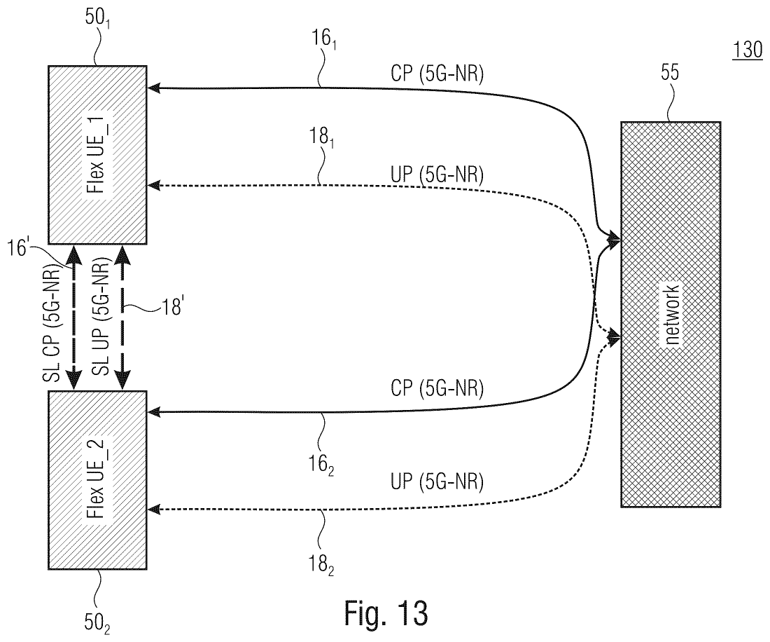

As another example embodiment, FIG. 13 shows an alternative inventive improvement over FIG. 6 achieved in a wireless communication network 130 through the addition of a flexible control plane 16′ and/or a flexible user plane 18′ between the user equipment 50₁ and 50₂ as an alternative or in addition to the flexible CP/UP in FIG. 12.

In connection with FIG. 13 example embodiments of the present invention relate to the following features:
flex devices such as UEs, i.e., devices that may adapt their SP as described herein, may make use of a flexible CP/UP to interconnect, e.g., via SL, to form an at least pairwise inter-UE connection
such flex CP/UP between UE 50₁ and UE 50₂ can be configured independently of the flex CP/UP between other UEs (or not at all) and/or to the remaining network 55
in addition to the above a 5G NR sidelink between UE 50₁ and UE 50₂ and/or further UEs is not excluded.

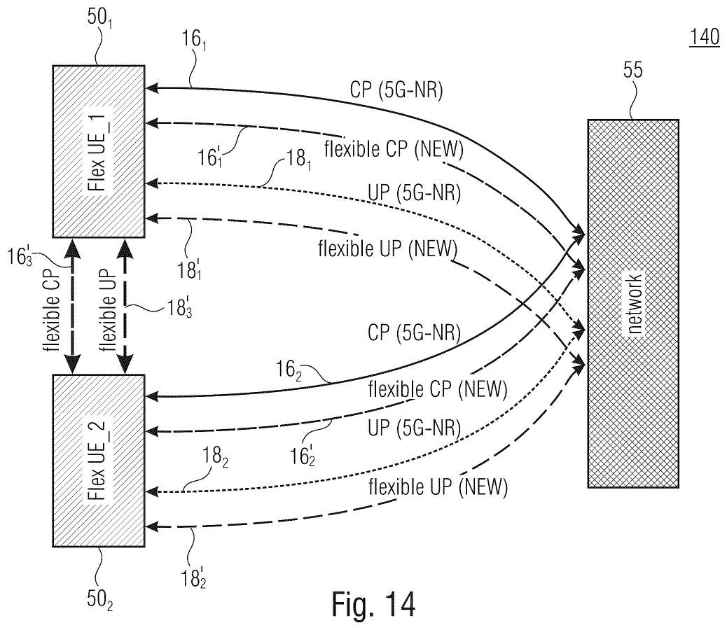

FIG. 14 shows a schematic block diagram of a wireless communication network 140 that is a combination of the features of wireless communication networks 120 and 130. In connection with FIG. 14, example embodiments provide at least for the following features:
how flex UEs and flex gNBs provide in addition to 5G NR-CP and/or 5G NR-UP a flexible CP/UP to interconnect the at least pairwise Flex DSP blocks
how flex UEs can make use of a flexible CP/UP to interconnect to form an at least pairwise inter-UE connection, e.g., using a sidelink
flex CP/UP between UE 50₁ and the network 55 can be configured independently of the flex CP/UP between UE 50₂ and network 55 (or not at all)
flex CP 16′₃ and/or flex UP 18′₃ between UE 50₁ and UE 50₂ can be configured independently of the flex CP/UP between other UEs or other UEs and network 55 (or not at all)
in addition to the above a 5G NR sidelink between UE 50₁ and UE 50₂ and/or further UEs is not excluded.

In other words, in addition to the 5G-NR control plane and user plane FIG. 14 shows connections between the network and the user equipment, flexible control plane and flexible user plane connections between the network and the user equipment and between the user equipment is provided to allow inter-UE forwarding (no active 5G-NR SL shown).

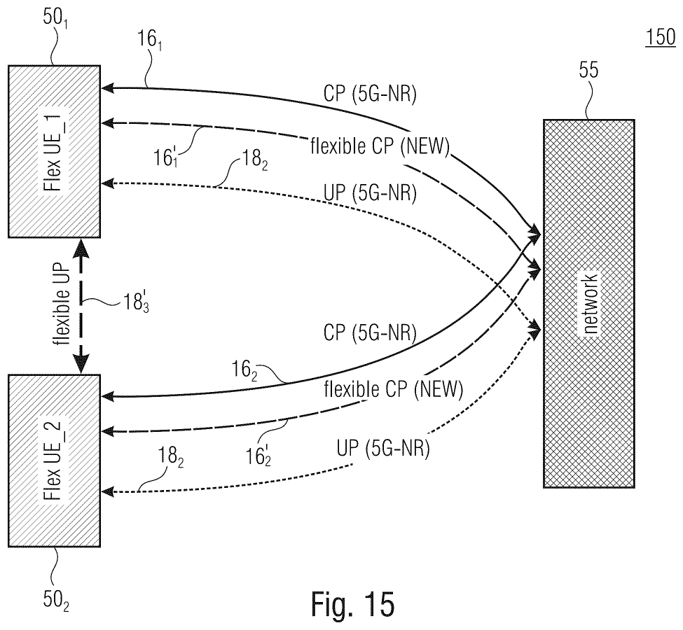

In connection with FIG. 15 showing a schematic block diagram of a wireless communication network 150 according to an example embodiment, the following features are presented:
how Flex UEs 50₁ and 50₂ and Flex gNBs of network 55 may provide in addition to 5G NR CP and/or 5G NR UP a flexible CP 16′₁, 16′₂ respectively to interconnect the at least pairwise Flex DSP blocks
how Flex UEs 50₁ and 50₂ make use of a flexible UP 18′₃ to interconnect to form an at least pairwise inter-UE connection
a flex CP 16′₁ between UE 50₁ and network 55 can be configured independently of the flex CP 16′₂ between UE 50₂ and network (or not at all)
a flex UP 18′₃ between UE 50₁ and UE 50₂ can be configured independently of the flex UP between other UEs or other UEs and network (or not at all)
in addition to the above a 5G NR sidelink between UE 50₁ and UE 50₂ and/or further UEs is not excluded.

FIG. 15 thus shows as per FIG. 14 with the exception that only a flexible user plane connection is provided between the user equipment (no active 5G-NR SL shown).

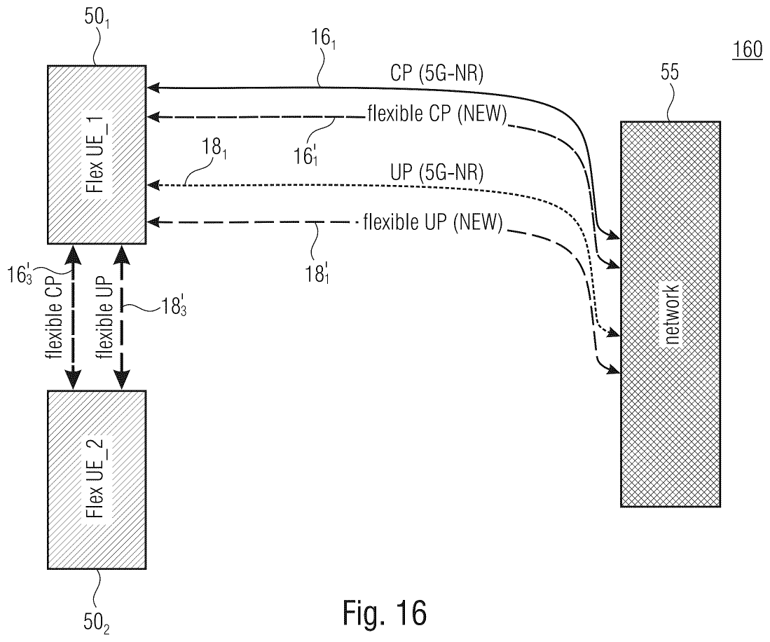

In connection with FIG. 16 showing a schematic block diagram of a wireless communication network 160 according to an example embodiment, the following features are presented:
a relaying functionality to UE 50₂ via UE 50₁ to the network 55, e.g., when UE 50₂ has no reliable or sufficient Uu link to the network 55
that a Flex UE and a Flex gNB provide in addition to 5G NR-CP 16₁ & 5G NR-UP 18₁ a flexible CP 16₁ and/or a flexible UP 18₁.
that Flex UEs may make use of a flexible CP 16′₃ and/or UP 18′₃ to interconnect to form an at least pairwise inter-UE connection
that flex CP 16′₃ and/or UP 18′₃ between UE 501 and UE 50₂ can be configured independently of the flex CP 16′₁ and/or the flex UP 18′₁ between UE 50₁ and the network 55 and/or between other UEs and/or other UEs and network (or not at all)
in addition to the above a 5G NR sidelink between UE 50₁ and UE 50₂ and/or further UEs is not excluded.

In other words, FIG. 16 shows a UE-to-UE relaying scenario: In addition to the 5G-NR control plane and user plane connections between the user equipment (side link, not shown), flexible control plane and flexible user plane connections between the network and one of the user equipment and between the user equipment is provided to allow inter-UE forwarding.

As may be seen from the example embodiments described in connection with FIG. 12 through FIG. 16, an adapted user-plane and/or an adapted control-plane may be operated in coexistence with known user-planes or control-planes. Such a coexistence may be implemented simultaneously or in an interleaved manner or sequentially. For example, different data streams may be processed differently between two same communication partners.

That is, proposed flexible new control-planes and/or a flexible user-plane can be implemented as a plane within an existing 5G-NR plane. This can be done, for example, by:
Assigning and/or mapping of content or data and/or by signalling two specific resources, wherein such resources can be logical, physical or combinations thereof; and/or
Assigning and/or mapping of content or data and/or a signal link to channels, wherein said channels can be logical, physical, or combinations thereof.

For example, a device according to an example embodiment may provide, e.g., by implementing the second configuration a user plane, UP, a control plane, CP, a flexible user plane (18′), and a new control plane (16′). The set of both user planes and both control planes may be provided by use of the second configuration alone, or by a combination of the first and the second configuration of the SP.

The second configuration of the device may allow SP processes to be mapped to any one or more of the UP, CP, flexible UP and flexible CP. Alternatively or in addition, an inter-CP and/or inter-UP signalling can be supported in part or in full. That is, at least the second configuration may comprise or provide for an inter CP and/or inter UP signalling. Such a signalling may be implemented between devices such as UEs operating with the second configuration, e.g., flexible devices and the network and/or between different processes of the configuration, see, FIGS. 6 and/or 10a-b.

Alternatively or in addition, The flexible CP and/or flexible UP may be mapped to same or different physical and/or logical channels when compared to the CP 16 and/or the UP 18, e.g. legacy UP and/or legacy CP. Alternatively or in addition, the NEW CP and/or the NEW UP can be embedded in a known, i.e., legacy CP and/or legacy UP respectively. Alternatively or in addition the NEW CP (16′) and/or NEW UP (18′) can support local breakout to at least one or a set, e.g., various layers in the SP processes and/or an implemented OSI layer stack.

Example embodiments described herein also relate to a signalling in connection with the flexible signal processing and/or the flexible control-plane and/or user-plane. Such a signalling may relate to signal capabilities, to indicate, to a different node a known capability of operation and/or may relate to an indication which configuration of the signal processing is implemented or will be implemented when performing communication. This may allow an adapted at the other side as well as a formulation of respective requests.

According to example embodiments, the signalling may relate to one or more of:
a capability signalling: a device according to an example embodiment may inform at least another device about its capability to support new DSP blocks and/or SP configurations
a handshake signalling between at least two devices according to an example embodiment to evaluate compatibility of supported new DSP blocks and/or SP configurations

Signalling with respect to DSP blocks may optionally include as an alternative or in addition:
a Downloading/updating at least one feature for at least one SP block used or to be used
an Authentication of DSP blocks e.g., using block chain like tags
a Secure download mechanism
an activation and/or deactivation mechanism for at least one process or block
a synchronization and scheduling mechanism for the SP
a calibration mechanism
a self-test mechanism
a reset mechanism (factory reset, default mode, dedicated/specific mode, e.g. low latency mode; power saving mode; . . . )
a closed loop signalling between one or more SP blocks/processes

### Introduction of Signalling Between Legacy and New UP and CP

The new UP and/or the new CP may allow for signalling to be replaced, simplified, duplicated, complemented or for existing signalling features to be enhanced through the introduction of commands and procedures to the legacy UP and/or CP.
parts or all signalling related to new DSP blocks can be mapped to the new, flexible CP and/or the new, flexible UP.
an Inter-CP or inter-UP referencing (signalling) can be supported partially or in full
a new CP and/or new UP can be mapped to same or different physical and/or logical channels like the legacy UP and/or legacy CP.
an example, crosswise referencing may use TCI, ME, RRC or similar commands in altered or unaltered manner
a new, flexible CP and/or new, flexible UP may be embedded in legacy CP and/or legacy CP, e.g. similar to VPN tunnelling therefore allowing more degrees with respect to an implementation
a new, flexible CP and/or new, flexible UP may support local breakout to various layers in the signal processing chain and/or OSI layer stack. This may allow for remote control of devices and/or signal processing elements in situ instead of or in addition to updating software and rebooting. This corresponds to an advantageous way of testing software on actively running devices in real time and/or with feedback loops. (Similar to debug mode).

In example embodiments, a device is configured for wireless communication in a wireless radio communication network;
wherein the device is configured for a signal processing, SP, such as a SP scheme for the wireless communication, the SP comprising at least one process, e.g., a functional block;
wherein in a first operation mode of the device, the SP is adapted to a first configuration of the SP; and wherein in a second operation mode of the device, the SP is adapted to a second configuration of the SP;
wherein the second configuration differs from the first configuration, e.g., by receiving reconfiguration information from the other end by at least one of;
a number of processes executed for the SP;
an interconnection, e.g., a chain and/or a loop between processes of the SP;
a substitution of a process of the first configuration by a different process operated in the second configuration;
a configuration of the at least one process, the configuration adapted based on adaptation information received e.g., from the other end after having started the first operation mode and prior to start the second operation mode; and
a configuration of the at least one process, the configuration adapted based on a fallback configuration to compensate for an error in the first configuration, e.g., prior to having implemented the 1^{st} mode.

In an example embodiment, in the second configuration,
the SP comprises an additional process replacing one or more process of the first configuration; or
the SP comprises an additional process being executed between a first and a second process of the first configuration, the additional process configured to process signal data provided by an output of a the first process, a result of the additional process provided to the second process; or
the SP comprises an additional process configured to bypass at least one process of the first configuration; or
the SP comprises an additional process configured to forward and/or reverse a signal flow path of the SP; or
the SP comprises an additional process configured to provides a recursive signal flow path in the SP.

In an example embodiment, the SP relates to at least one of a user plane and a control plane of the wireless communication.

In an example embodiment, the second configuration differs from the first configuration by at least the configuration of the at least one process and in view of a polar coding used in a user plane of the communication to be used in either the first configuration or the second configuration.

In an example embodiment, the device is to provide at least a part of the SP in a digital domain.

In an example embodiment, the device is configured to maintain a first communication using the first configuration sequence and to maintain a second communication using the second configuration, wherein the device is to maintain the first communication and the second communication sequentially or in parallel.

In an example embodiment, the device is configured for implementing a first communication using the first configuration; and for implementing a second communication using the second configuration; wherein at least one of the first communication and the second communication is a sidelink communication.

In an example embodiment, the device is configured for implementing a first communication using the first configuration; and for implementing a second communication using the second configuration; wherein at least one of the first communication and the second communication is an uplink communication or a downlink communication.

In an example embodiment, in a third operation mode of the device, the SP is adapted to a third configuration of the SP, wherein the device is adapted to maintain communication using the third sequence and to communicate in parallel with at least a first different device using the second and configuration and with a second different device using the third and configuration.

In an example embodiment, the device is configured to wirelessly receive a request signal indicating a request to provide the second configuration of the SP and to switch to the second operation mode based on the request signal.

In an example embodiment, the device is configured to evaluate the request signal for an explicit information indicating the second configuration; and to adapt the SP according to the explicit information such as parameters; and/or
wherein the device is to evaluate the request signal for an implicit information such as an entry in a codebook or the like indicating the second configuration and to derive the second configuration from the implicit information; and to adapt the SP accordingly.

In an example embodiment, the device is configured for a standardised communication in the first configuration mode and for an unstandardized communication in the second configuration.

In an example embodiment, the device is configured for the SP in the second operation mode to comprise an increased number of processes executed for the SP when compared to the first operation mode.

In an example embodiment, parameters of at least one process of the increased number is controlled by the user equipment.

In an example embodiment, at least one additional process of the second configuration comprises a digital twin process.

In an example embodiment, the device is configured for the SP in the second operation mode to comprise a decreased number of processes executed for the SP when compared to the first operation mode.

In an example embodiment, to obtain the decreased number, the device is to omit a process of the first configuration.

In an example embodiment, at least one omitted process of the first configuration comprises a digital twin process.

In an example embodiment, the device is configured for the SP in the second operation mode to comprise a changed interconnection between processes of the SP;

to generate an additional loop or path in the SP; and/or to remove a loop or path in the SP.

In an example embodiment, the second configuration of the SP is adapted for a flexible user plane and/or flexible control plane of the communication.

In an example embodiment, the second configuration differs from the first configuration in view of a physical layer, PHY, of the communication.

In an example embodiment, the second configuration differs from the first configuration in view of processing Internet Protocol, IP, data, of the communication, e.g., in view of providing an analogue to digital conversion, ADC.

In an example embodiment, the device is adapted to transmit a signal to the wireless communication network indicating a capability to deviate from the first configuration by use of the second configuration.

In an example embodiment, in connection with the second configuration, the device is configured to at least one of:
downloading and/or updating a feature for a process such as a DSP block used or to be used in the second configuration;
an authentication of a process of the second configuration such as a DSP block, e.g., using block chain like tags
use a secure download mechanism for downloading information to implement the second configuration;
an activation and/or deactivation mechanism for a process of the first or second configuration
a synchronization and scheduling mechanism
a calibration mechanism
a self-test mechanism
a reset mechanism such as a factory reset, a default mode, a dedicated/specific mode, e.g. low latency mode; power saving mode
a closed loop signalling between processes such as DSP blocks.

In an example embodiment, the device is adapted for a handshake signalling procedure with a different device of the wireless communication network to evaluate compatibility of supported deviations from the respective first configuration of the device and the other device.

In an example embodiment, the device is or comprises a user equipment, UE, a base station and/or a relay device.

In an example embodiment, the device is implemented as a base station and being adapted to maintain a multitude of configurations in parallel, each configuration of the multitude of configurations being device-dependently different from one another based on a communication with a device for which the configuration is used.

In an example embodiment, a method for operating a device for a wireless communication in a wireless communication network, comprises
configuring the device for a signal processing, SP, for the wireless communication, the SP comprising at least one process;
operating the device in a first operation mode in which the SP is adapted to a first configuration of the SP; and
operating the device in a second operation mode in which the SP is adapted to a second configuration of the SP;
such that the second configuration differs from the first configuration by at least one of:
a number of processes executed for the SP;
an interconnection between processes of the SP;
a substitution of a process of the first configuration by a different process operated in the second configuration;
a configuration of the at least one process, the configuration adapted based on adaptation information received after having started the first operation mode and prior to start the second operation mode; and
a configuration of the at least one process, the configuration adapted based on a fallback configuration to compensate for an error in the first configuration.

In an example embodiment, a computer readable digital storage medium has stored therein a computer program having a program code for performing, when running on a computer, a method described herein.

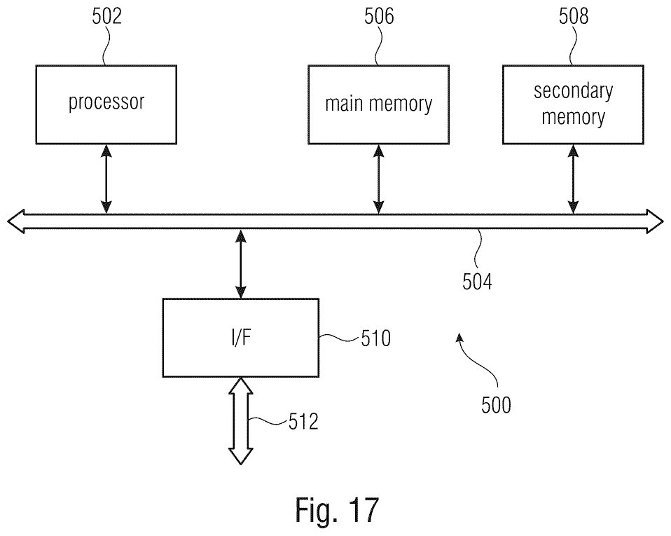

Various elements and features of the present invention may be implemented in hardware using analogue and/or digital circuits, in software, through the execution of instructions by one or more general purpose or special-purpose processors, or as a combination of hardware and software. For example, example embodiments of the present invention may be implemented in the environment of a computer system or another processing system. FIG. 17 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the form of electronic, electromagnetic, optical, or other signals capable of being handled by a communications interface. The communication may use a wire or a cable, fibre optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some example embodiments according to the invention comprise a data carrier having electronically readable control signals, which are capable of cooperating with a programmable computer system, such that one of the methods described herein is performed.

Generally, example embodiments of the present invention may be implemented as a computer program product with a program code, the program code being operative for performing one of the methods when the computer program product runs on a computer. The program code may for example be stored on a machine-readable carrier.

Other example embodiments comprise the computer program for performing one of the methods described herein, stored on a machine-readable carrier. In other words, an example embodiment of the inventive method is, therefore, a computer program having a program code for performing one of the methods described herein, when the computer program runs on a computer.

A further example embodiment of the inventive methods is, therefore, a data carrier (or a digital storage medium, or a computer-readable medium) comprising, recorded thereon, the computer program for performing one of the methods described herein. A further example embodiment of the inventive method is, therefore, a data stream or a sequence of signals representing the computer program for performing one of the methods described herein. The data stream or the sequence of signals may for example be configured to be transferred via a data communication connection, for example via the Internet. A further example embodiment comprises a processing means, for example a computer, or a programmable logic device, configured to or adapted to perform one of the methods described herein. A further example embodiment comprises a computer having installed thereon the computer program for performing one of the methods described herein.

In some example embodiments, a programmable logic device (for example a field programmable gate array) may be used to perform some or all of the functionalities of the methods described herein. In some example embodiments, a field programmable gate array may cooperate with a microprocessor in order to perform one of the methods described herein. Generally, the methods are performed by any hardware apparatus.

While this invention has been described in terms of several advantageous example embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A device configured for wireless communication in a wireless communication network;
wherein the device is configured for a signal processing, SP, for the wireless communication, the SP comprising at least one process;
wherein in a first operation mode of the device, the SP is adapted to a first configuration of the SP; and wherein in a second operation mode of the device, the SP is adapted to a second configuration of the SP; wherein in the second configuration, the device is configured for a flexible user plane and/or a flexible control plane;
wherein the second configuration differs from the first configuration by at least one of:
a number of processes executed for the SP;
an interconnection between processes of the SP;
a substitution of a process of the first configuration by a different process operated in the second configuration;
a configuration of the at least one process, the configuration adapted based on adaptation information received after having started the first operation mode and prior to start the second operation mode; and
a configuration of the at least one process, the configuration adapted based on a fallback configuration to compensate for an error in the first configuration

2. The device of claim 1, wherein in the second configuration, the SP comprises at least one of:
an additional process replacing one or more processes of the first configuration;
an additional process being executed between a first and a second process of the first configuration, the additional process configured to process signal data provided by an output of the first process, a result of the additional process provided to the second process;
an additional process configured to bypass at least one process of the first configuration;
an additional process configured to forward and/or reverse a signal flow path of the SP; and
an additional process configured to provides a recursive signal flow path in the SP.

3. The device of claim 1, wherein the SP relates to at least one of a user plane and a control plane of the wireless communication.

4. The device of claim 1, wherein the device is to provide at least a part of the SP in a digital domain.

5. The device of claim 1, being configured to maintain a first communication using the first configuration and to maintain a second communication using the second configuration, wherein the device is to maintain the first communication and the second communication sequentially or in parallel.

6. The device of claim 1, being configured for implementing a first communication using the first configuration; and for implementing a second communication using the second configuration; wherein at least one of the first communication and the second communication is a sidelink communication.

7. The device of claim 1, being configured for implementing a first communication using the first configuration; and for implementing a second communication using the second configuration; wherein at least one of the first communication and the second communication is an uplink communication or a downlink communication.

8. The device of claim 1, wherein in a third operation mode of the device, the SP is adapted to a third configuration of the SP, wherein the device is adapted to maintain communication using the third configuration and to communicate in parallel with at least a first different device using the second configuration and with a second different device using the third configuration.

9. The device of claim 1, wherein the device is to wirelessly receive a request signal indicating a request to provide the second configuration of the SP and to switch to the second operation mode based on the request signal;
wherein the device is to evaluate the request signal for an explicit information indicating the second configuration; and to adapt the SP according to the explicit information; and/or
wherein the device is to evaluate the request signal for an implicit information indicating the second configuration and to derive the second configuration from the implicit information; and to adapt the SP accordingly.

10. The device of claim 1, wherein the device is to evaluate an input information and/or an output information of at least one SP process to obtain an evaluation result and to derive the second configuration based on the evaluation result; and to adapt the SP accordingly.

11. The device of claim 1, wherein the device is adapted for a standardised communication in the first configuration mode and for an unstandardized communication in the second configuration.

12. The device of claim 1, wherein the device is configured for the SP in the second operation mode to comprise an increased number of processes executed for the SP when compared to the first operation mode;
wherein parameters of at least one process of the increased number is controlled by the user equipment.

13. The device of claim 12, wherein at least one additional process of the second configuration comprises a digital twin process.

14. The device of claim 1, wherein the device is configured for the SP in the second operation mode to comprise a decreased number of processes executed for the SP when compared to the first operation mode; wherein to obtain the decreased number, the device is to omit a process of the first configuration;
wherein at least one omitted process of the first configuration comprises a digital twin process.

15. The device of claim 1, wherein the device is configured for the SP in the second operation mode to, at least one of:
comprise a changed interconnection between processes of the SP;
generate an additional loop or path in the SP; and
remove a loop or path in the SP.

16. The device of claim 1, wherein the device is adapted to transmit an assistance information to a different device, e.g., a base station; wherein the second configuration is based on the assistance information; wherein the assistance information comprises information indicating at least one of:
a transmit power level or a transmit power margin
a transmit power spectral density or spectral density margin;
a waveform of a transmitted signal;
an encoding or a configuration thereof, e.g., low density parity check, LDPC, turbo codes, polar codes;
an error correction mechanism;
packet retransmissions;
a diversity scheme and/or a multiplexing scheme;
a transmit and/or receive antenna scheme;
an encryption on one or different layers;
an authentication;
a measure, logging and/or reporting of at least one parameter; and
an encapsulation of specific information or control elements; configurations thereof by suitable parameters or combinations of the above.

17. The device of claim 16, wherein in response to transmit the assistance information, the device is configured to select the second configuration based on at least one of:
a reception of a request signal indicating a requested configuration;
a triggering event and/or a triggering threshold; and
a selection of the device from a set of preconfigured options.

18. The device of claim 1, wherein the second configuration of the SP is adapted for a flexible user plane and/or flexible control plane of the communication.

19. The device of claim 1, configured for providing, by implementing the second configuration a user plane, UP, a control plane, CP, a flexible user plane, and a new control plane;
wherein the second configuration of the device allows SP processes to be mapped to any one or more of the UP, CP, flexible UP and new CP;
wherein the second configuration comprises an inter-CP signalling and/or inter-UP signalling.

20. The device of claim 19, wherein the flexible CP maps to a same or different physical and/or logical channel when compared to the CP, the e.g. legacy UP and/or wherein the flexible UP maps to a same or different physical and/or logical channel when compared to the UP, e.g. legacy UP;
wherein the flexible CP is embedded in a legacy CP and/or
wherein the flexible UP is be embedded in a legacy UP;
wherein the flexible CP and/or the flexible UP supports a local breakout to at least one or a set of layers in the SP processes and/or an implemented OSI layer stack.

21. The device of claim 1, wherein the second configuration differs from the first configuration in view of at least one of:
a physical layer, PHY, of the communication; and
processing Internet Protocol, IP, data, of the communication, e.g., in view of providing an analogue to digital conversion, ADC.

22. The device of claim 1, wherein the device is adapted to transmit a signal to the wireless communication network indicating a capability to deviate from the first configuration by use of the second configuration;
wherein, in connection with the second configuration, the device is configured to at least one of:
downloading and/or updating a feature for a process such as a DSP block used or to be used in the second configuration;
an authentication of a process of the second configuration such as a DSP block, e.g., using block chain like tags
use a secure download mechanism for downloading information to implement the second configuration;
an activation and/or deactivation mechanism for a process of the first or second configuration
a synchronization and scheduling mechanism
a calibration mechanism
a self-test mechanism
a reset mechanism such as a factory reset, a default mode, a dedicated/specific mode, e.g. low latency mode; power saving mode
a closed-loop signalling between processes such as DSP blocks

23. The device of claim 1, wherein the device is adapted for a handshake signalling procedure with a different device of the wireless communication network to evaluate compatibility of supported deviations from the respective first configuration of the device and the other device.

24. The device of claim 1, wherein the device is or comprises a user equipment, UE, a base station and/or a relay device.

25. The device of claim 1, being implemented as a base station and being adapted to maintain a multitude of configurations in parallel, each configuration of the multitude of configurations being device-dependently different from one another based on a communication with a device for which the configuration is used.

26. A device configured for wireless communication in a wireless communication network;
wherein the device is configured for receiving, from another device, assistance information, and for determining a requested signal processing requested from the different device based on the assistance information; and to transmit the requested signal processing to the different device; and/or
wherein the device is configured to reproduce or reconstruct the signal processing of the different device based on the assistance information and to adapt the signal processing of the device accordingly.

27. A method for operating a device for a wireless communication in a wireless communication network, the method comprising:
configuring the device for a signal processing, SP, for the wireless communication, the SP comprising at least one process;
operating the device in a first operation mode in which the SP is adapted to a first configuration of the SP; and
operating the device in a second operation mode in which the SP is adapted to a second configuration of the SP; wherein in the second configuration, a flexible user plane and/or a flexible control plane is provided;
such that the second configuration differs from the first configuration by at least one of:
a number of processes executed for the SP;
an interconnection between processes of the SP;
a substitution of a process of the first configuration by a different process operated in the second configuration;
a configuration of the at least one process, the configuration adapted based on adaptation information received after having started the first operation mode and prior to starting the second operation mode; and
a configuration of the at least one process, the configuration adapted based on a fallback configuration to compensate for an error in the first configuration
